(19) United States
(12) Patent Application Publication
(10) Pub. No.: US 2019/0084140 A1
(43) Pub. Date: Mar. 21, 2019

(54) Multifunctional Pliers

(71) Applicant: Glenn Cooke, Hamilton (CA)

(72) Inventor: Glenn Cooke, Hamilton (CA)

(21) Appl. No.: 16/135,453

(22) Filed: Sep. 19, 2018

Related U.S. Application Data
(60) Provisional application No. 62/561,457, filed on Sep. 21, 2017.

(51) Int. Cl. B25F 1/00; B25B 7/22; B25B 7/02

(52) U.S. Cl. CPC B25F 1/003; B25B 7/02; B25B 7/22

(57) ABSTRACT

Multifunctional pliers include a right lever and a left lever, with an upper working portion which includes right and left tip ends at one end respectively, and a handle portion which includes right and left handles at the other end respectively, the working portion and handle portion connected at the pivot axis, wherein the levers and are of substantially equal length and are pivotally hinged together about the pivot axis which is spaced a preselected distance T from the right and left tip ends, and a preselected distance H from the left and right handle ends. The working portion includes a utility portion extending longitudinally from the pivot axis to a tip web, the utility portion configured for cutting and gripping and includes a cutting portion and gripping portion respectively. The working portion includes a needle nose portion which extends longitudinally from the tip web to the right and left tips. The multifunctional pliers claimed in claim 1 wherein the needle nose portion includes a pry surface which when viewed from the side, extends laterally away from an outer face plane, the pry surface is inclined at an angle theta relative to the lateral direction wherein angle theta is between 2° to 30°.

### THE FIELD OF INVENTION

The present concept relates to hand tools and more particularly relates to pliers that have multi-functional features.

### BACKGROUND OF THE INVENTION

There are numerous types of manual pliers that are available in the marketplace currently. Some of the more popular ones are known as linesmen pliers, needle nose pliers, diagonal pliers or side cutters, slip joint pliers, pincers, tongue and groove pliers, round nose pliers, and locking pliers. Of these, the most commonly utilized are the needle nose pliers, sometimes called long nose pliers, and the linesmen pliers which are often also called square nosed or side cutting pliers.

The needle nose or long nose pliers in particular have highly tapered longer tips for grasping wires and other small objects in confined spaces. The disadvantage of these pliers is that they tend to deform due to the length of the nose of the pliers they tend to deform and/or flex under high loads. It is difficult to obtain very high clamping forces at the end of needle nose pliers due to the fact that the long nose pliers or needle nose pliers have such a long nose extending from the pivot point forward. In other words, the mechanical advantage or the lever advantage between the handles of the pliers and the end of the needle nose is less than other pliers, for example linesmen pliers.

Linesmen pliers on the other hand have short flat jaws and typically broader gripping surfaces than needle nose pliers. Most importantly, linesmen pliers have a higher mechanical advantage than needle nose or long nose pliers since linesmen pliers typically have a much greater mechanical lever action than needle nose pliers.

The mechanical lever advantage is a function of the distance of the handles to the pivot point versus the distance to the end of the nose of the pliers to the pivot point. In other words, a set of pliers that have very long handles relative to the pivot point and very short jaw portions relative to the pivot point, would have a large mechanical advantage.

It is also generally understood that most tradesmen want to minimize the number of hand tools that they have to carry with them to the job site. Therefore pliers which have multi-functional capabilities are desirable, particularly if those capabilities are able to reduce the number of pliers that a tradesmen has to carry in their tool pouch.

The present concept is a multi-functional plier which combines together the benefits of the linesmen pliers with those of a needle nose pliers.

It is an object of the present concept to provide a set of pliers which include needle nose jaws which are significantly shorter than those found on needle nose pliers and or long nose pliers and yet enjoy the mechanical lever advantage found in linesmen pliers.

It is a further object of this concept to combine together some of the advantages found in linesmen pliers and/or combination pliers with those found in needle nose pliers or long nose pliers. In other words the present concept may include side cutting capability and/or serrated gripping capability together with needle nose accessibility and linesmen griping power.

### BRIEF DESCRIPTION OF THE DRAWINGS

FIG. 1 is a schematic inner face plan view of utility pliers shown in the closed position.

FIG. 2 is a schematic right side plan view of the utility pliers shown in FIG. 1.

FIG. 3 is a schematic outer face plan view of the utility pliers shown in FIG. 1.

FIG. 4 is a schematic left side plan view of the utility plier shown in FIG. 1.

FIG. 5 is a schematic top inner face perspective view of utility pliers shown in FIG. 1 in the open position.

FIG. 6 is a schematic inner face plan view of side cutting pliers shown in the closed position.

FIG. 7 is a schematic right side plan view of the side cutting pliers shown in FIG. 1.

FIG. 8 is a schematic outer face plan view of the side cutting pliers shown in FIG. 1.

FIG. 9 is a schematic left side plan view of the side cutting plier shown in FIG. 1.

FIG. 10 is a schematic top inner face perspective view of side cutting pliers shown in FIG. 1 in the open position.

### DETAILED DESCRIPTION OF THE PREFERRED EMBODIMENT

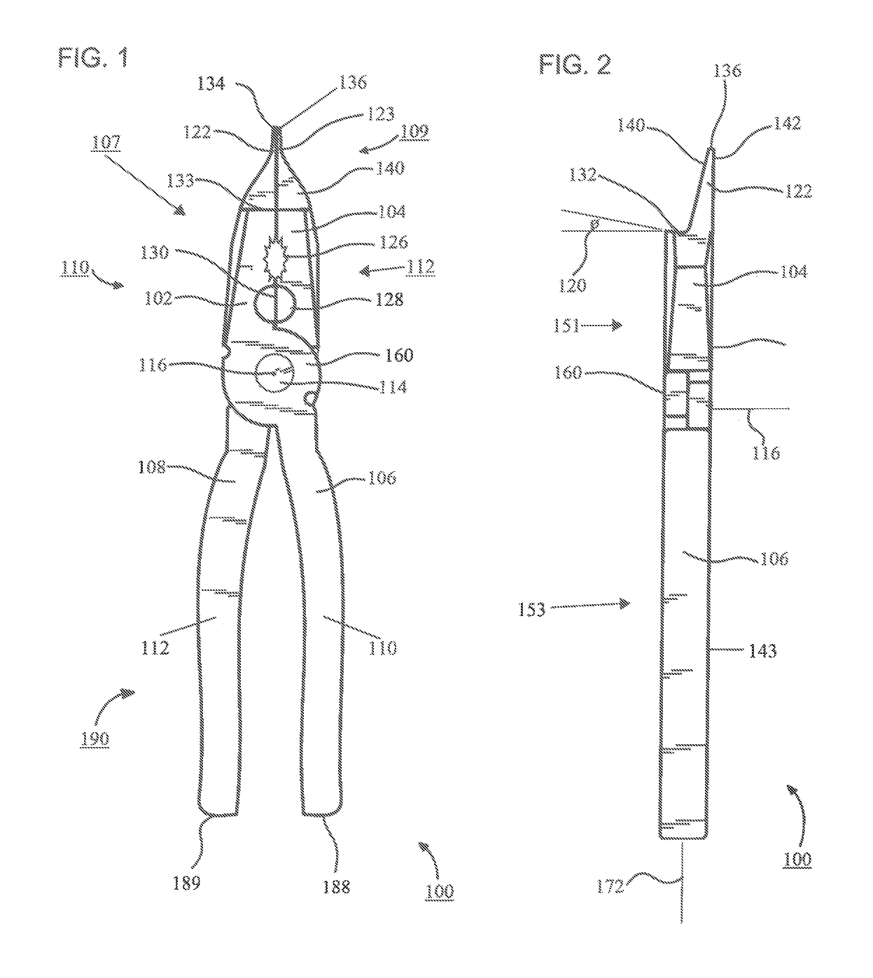

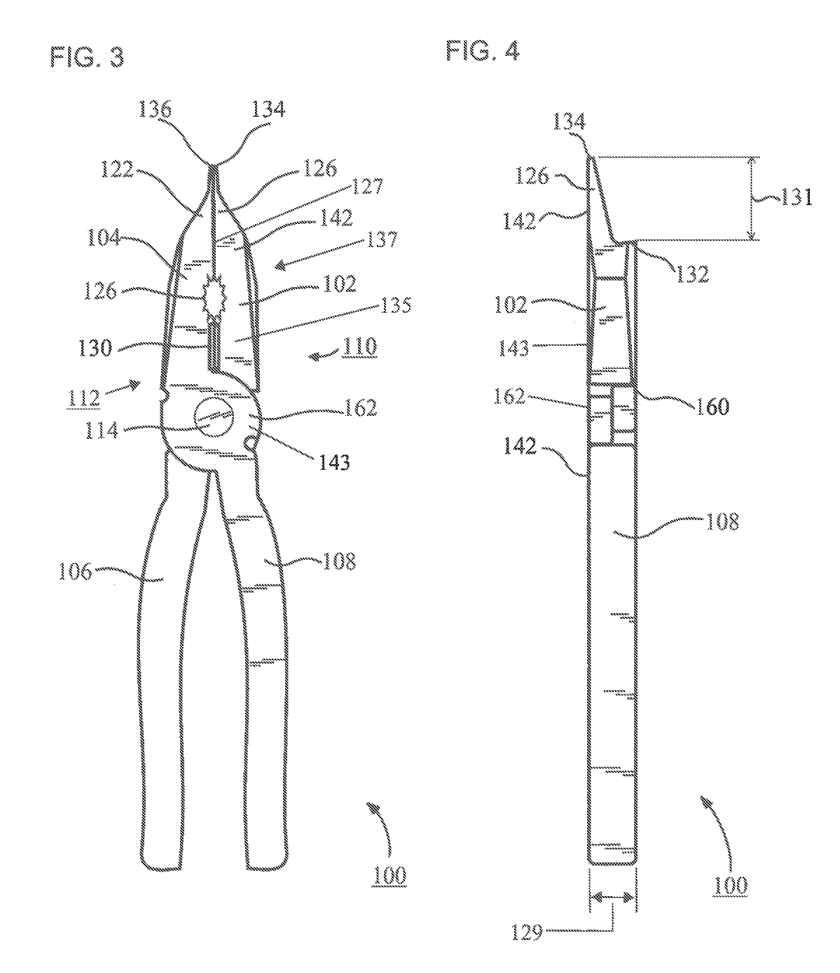

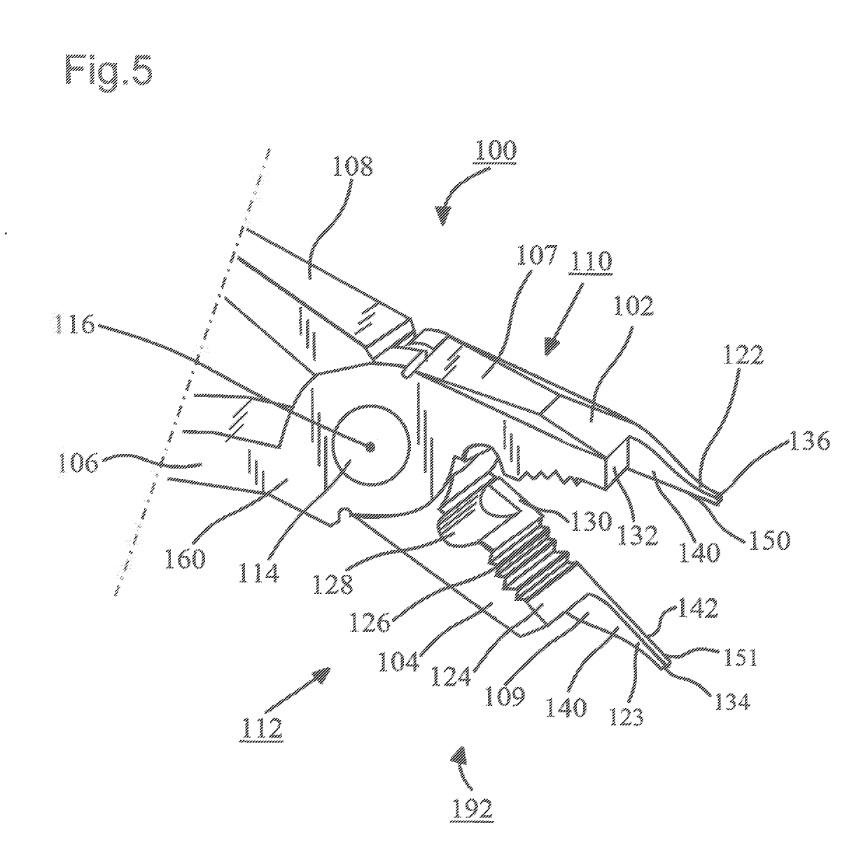

First of all referring to FIGS. 1-5 which depict utility pliers 100 which include the following major components namely left lever 110 connected to right lever 112 with pin 114 which allows levers 110 and 112 to pivot about pivot axis 116. Levers 110 and 112 are shown in the open position 192 in FIG. 5 and shown in the closed position 190 in FIGS. 1-4. Levers 110 and 112 are substantially the same length.

Each of the levers 110 and 112 includes a left jaw 102 and right jaw 104 which includes a utility portion 107 and a needle nose portion 109.

Utility portion 107 includes relief 128, cutting edges 130, serrated surface 126 and a broad gripping face 124.

Needle nose portion 109 includes a left tip 122, a right tip 123 left tip end 134 and right tip end 136, a tip inner face 140, a tip outer face 142, a grip surface 150, and pry surface 132.

Lever 110 further includes right handle 106 and lever 112 further includes left handle 108, and plier inner face 160 and plier outer face 162.

FIG. 5 shows a plier inner face 160 with the levers 110 and 112 in the open position 192.

Referring now to FIGS. 1-4 the reader will note that pry surface 132 is inclined at an angle theta shown as numeral 120 in FIG. 2 relative to the lateral direction. Angle theta is preferably 2° to 30° and is more preferably 5°.

The longitudinal direction is shown as 172 in FIG. 2.

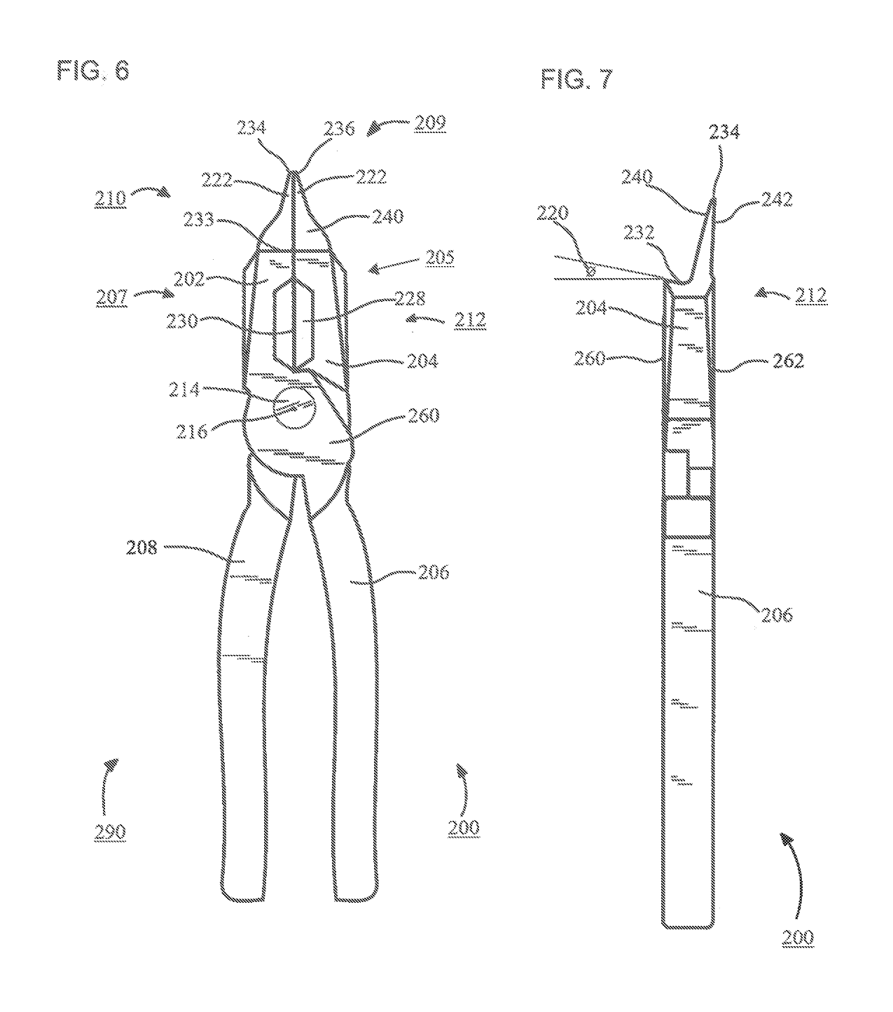

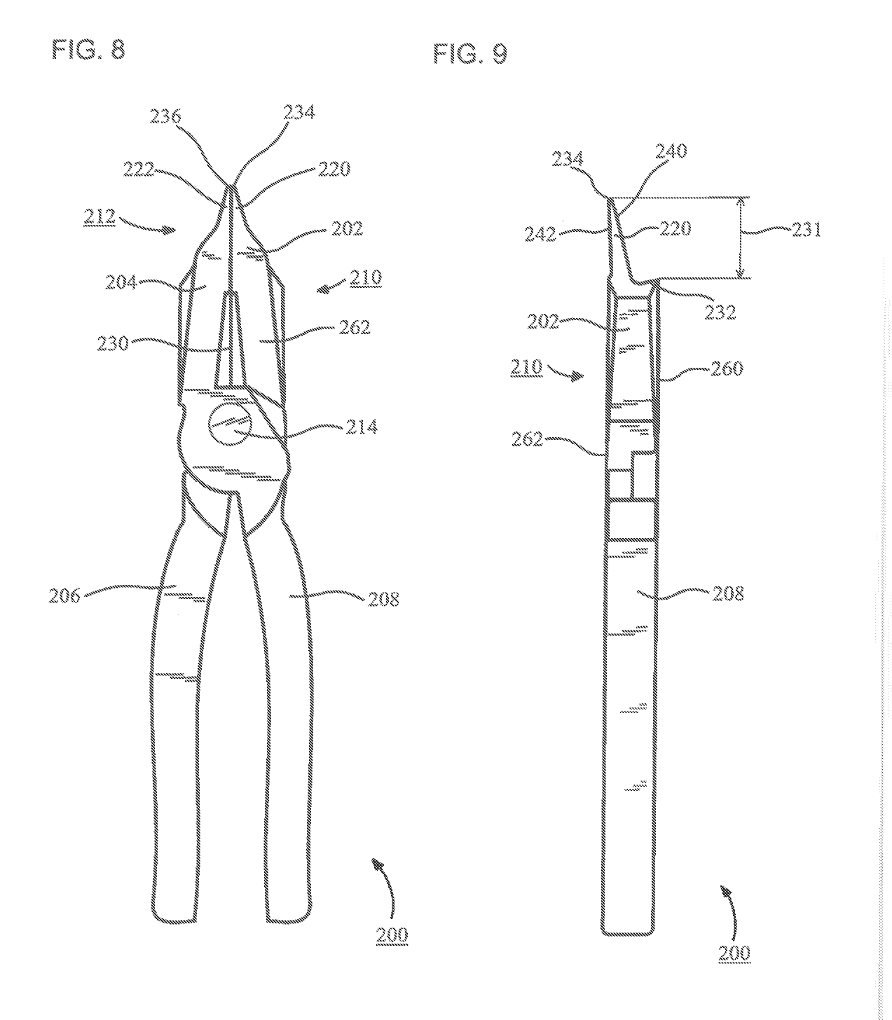

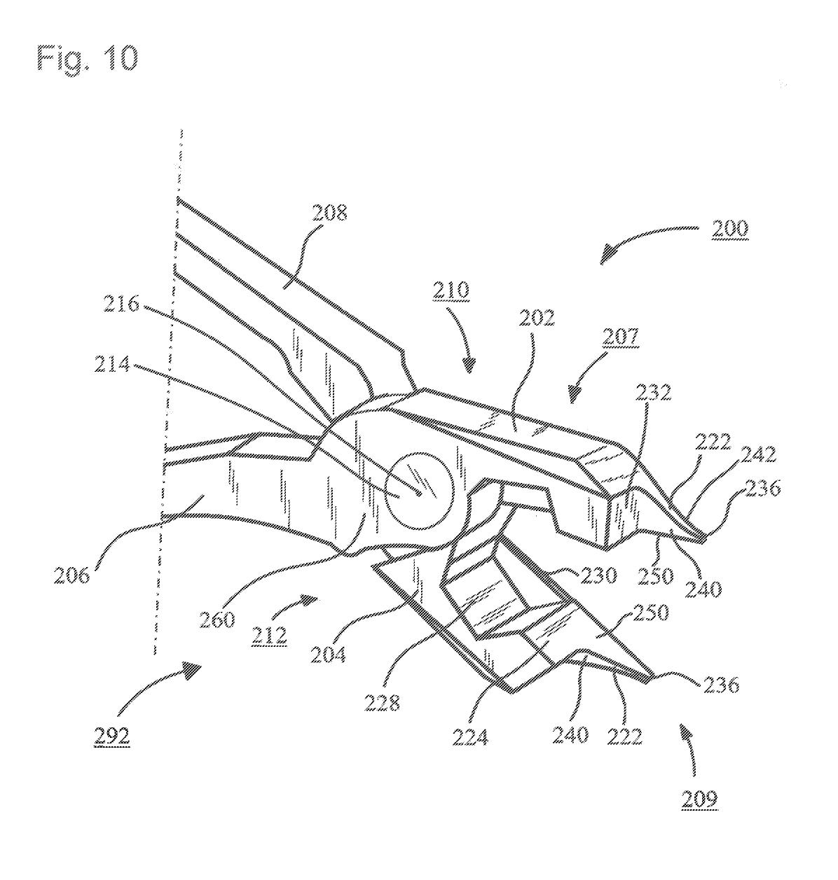

Referring now to FIGS. 6-10 which depict side cutting pliers 200 which includes the following major components namely lever 210 connected to lever 212 with pin 214 which allows the levers 210 and 212 to pivot about pivot axis 216. Levers 210 and 212 are shown in the open position 292 in FIG. 10 and shown in the closed position 290 in FIGS. 5-9.

Each of the levers 210 and 212 includes a jaw 207 which includes a utility portion 204 and a needle nose portion 209.

Utility portion 204 includes a cutting portion 205 includes relief 228, cutting edge 230 and a broad gripping face 224.

Needle nose portion 209 includes a tip 222, a right tip end 236, left tip end 234, a tip inner face 240, a tip outer face 242, a grip surface 250, and pry surface 232.

Lever 210 further includes handle 206 and lever 212 further includes handle 208.

FIG. 10 shows a plier inner face 260 with the levers 210 and 212 in the open position 292.

Referring now to FIGS. 5-9 the reader will note that pry surface 232 is inclined at an angle theta shown as numeral 220 in FIG. 7 relative to the lateral direction. Angle theta is preferably 3° to 30° and is more preferably 5°

The longitudinal direction is shown as 272 in FIG. 7

Multifunctional pliers which include a right lever 112 and a left lever 110, with an upper working portion 151 which includes right and left tip ends 123, 122 at one end respectively, and a handle portion 153 which includes right and left handles 106, 108 at the other end respectively, the working portion and handle portion connected at the pivot axis 116, wherein the levers 112 and 110 are of substantially equal length and are pivotally hinged together about the pivot axis 116 which is spaced a preselected distance T from the right and left tip ends 123, 122 and a preselected distance H from the left and right handle ends 189, 188.

The utility portion may simply make a connection from the needle nose portion 109 to the handles 108 and 106. The gripping portion 137 and the cutting portion 135 are optional and may or may not be present. In embodiment side cutting pliers 200 only a cutting portion 205 is included in addition to the needle nose portion 209.

The working portion 151 includes a needle nose portion 109 which extends longitudinally from the tip web 133 W to the right and left tips 123,122. The working portion 151 also includes a utility portion 107 extending longitudinally 172 from the pivot axis 116 to the tip web 133 W for rigidly connecting to the needle nose portion 109.

The needle nose portion includes a pry surface 132 which when viewed from the side, extends laterally away from an outer face plane 143, the pry surface is inclined at an angle theta 120 relative to the lateral direction wherein angle theta is between 2° to 30°.

The needle nose portion includes a pry surface 132 extending laterally away from an outer face plane, the pry surface is inclined at an angle theta 120 relative to the lateral direction wherein angle theta is 5°.

Pliers 100 further include a utility portion 107 extending longitudinally from the pivot axis 116 to the tip web 133, the utility portion may be configured for cutting and gripping in which case they will include a cutting portion 135 and gripping portion 137 respectively.

The utility portion 107 may include a cutting portion 135 spaced closest longitudinally to the pivot axis 116, followed by a gripping portion 137 next closest longitudinally to the pivot axis 116, followed by the needle nose portion 109 spaced furthest longitudinally from the pivot axis 116.

The needle nose portion when viewed from the side is thickest at the tip web 133 and tapers to the tip ends 122, 123.

The needle nose portion when viewed from the side is thinner than the overall thickness of the pliers Th at the tip web 133 thereby providing space for the pry surface.

The needle nose portion when viewed from the side is less than 60% of the overall thickness of the pliers Th at the tip web 133 thereby providing space for the pry surface.

Multifunctional pliers which preferably include a right lever 112 and a left lever 110, with an upper working portion 151 which includes right and left tip ends 123, 122 at one end respectively, and a handle portion 153 which includes right and left handles 106, 108 at the other end respectively, the working portion and handle portion connected at the pivot axis 116, wherein the levers 112 and 110 are of substantially equal length and are pivotally hinged together about the pivot axis 116 which is spaced a preselected distance T from the right and left tip ends 123, 122 and a preselected distance H from the left and right handle ends 189, 188.

The working portion 151 preferably includes a utility portion 107 extending longitudinally from the pivot axis 116 to a tip web 133, the utility portion configured for cutting and gripping and includes a cutting portion 135 and gripping portion 137 respectively. The working portion 151 preferably further includes a needle nose portion 109 which extends longitudinally from the tip web 133 to the right and left tips 123,122.

The needle nose portion includes a pry surface 132 which when viewed from the side, extends laterally away from an outer face plane 143, the pry surface is inclined at an angle theta 120 relative to the lateral direction wherein angle theta is between 2° to 30°.

The needle nose portion includes a pry surface 132 extending laterally away from an outer face plane, the pry surface is inclined at an angle theta 120 relative to the lateral direction wherein angle theta is 5°.

The ratio H/T is preferably greater than 2.8 providing a greater mechanical advantage of the needle nose portion than standard needle nose pliers. The tip length is defined as L 131 and the ratio W/L is greater than 1.3 providing a greater stiffness of the needle nose portion than standard needle nose pliers.

### In Use

The reader will note that utility pliers 100 and side cutting pliers 200 provide for a mechanical advantage at tip ends 134,136 and tip ends 234, 236 which is normally not available from traditional needle nose pliers. The mechanical advantage is proportional to the distance from the right handle end 188 and left handle end 189 to the pivot axis 116 and is denoted as H in the chart below and the distance from the tip end 136 to the pivot axis 116 is denoted as T in the chart below. The ratio of H/T is proportional to the mechanical advantage provided by the pliers. In other words, the longer the handle 106 relative to the jaws 102, the greater the mechanical advantage.

Chart A below summarizes the ratio of the handle end to pivot distance (H) divided by the tip end to pivot distance (T) namely the ratio of H/T which is proportional to the mechanical advantage of the pliers. The chart shows the mechanical advantage for the average of standard needle nose pliers available in the marketplace, standard utility pliers and utility pliers 100 as per the present concept, as well as standard or normal linesmen pliers and side cutting pliers 200 as per the present concept. The reader will note that the mechanical advantage at tip end 136 is 2.8 and at tip end 236 4.1 versus the mechanical advantage of a standard needle nose plier which is approximately 1.8. Measurements taken on various needle nose pliers available in the market place indicates that the mechanical advantage ratio H/T varies anywhere from 1 to 2 for standard available needle nose pliers. Measurements taken on utility pliers indicates that the mechanical advantage ratio H/T ranges anywhere from approximately 2.5 to 3.5 and measurements taken on linesmen pliers commercially available in the market place ranges anywhere from 3.5 to 4.5.

Similarly the stiffness of the jaws of standard needle nose pliers is also considerably less than the stiffness of the needle nose portion 109 and or needle nose portion 209 of the utility pliers 100 and the side cutting pliers 200.

Chart B below summarizes tip stiffness which is proportional to the web (W) divided by the length of the tip (L) and indicates measurements taken from the average of standard needle nose pliers and utility pliers 100 and side cutting pliers 200. The stiffness can be approximated as a ratio of the tip web denoted as W and as 133 in FIGS. 1 and 233 in FIG. 6 divided by the tip length denoted as L shown as tip length 131 and 231 in FIGS. 4 and 9. The reader will note that the tip stiffness for utility pliers 100 is approximately three times greater than standard needle nose pliers as shown in chart B and is approximately four times higher for side cutting pliers 200 than standard needle nose pliers. This means that there will be significantly less deflection of the tip ends 136 and 236 in the presently described concepts in contrast or relative to standard needle nose pliers.

CHART A
Mechanical Advantage

| | | Utility pliers | Side cutting pliers |
|---|---|---|---|
| | Needle | 100 & Utility | 200 & Linesmen |
| | nose mm | pliers mm | pliers mm |
| Handle end | 132 | 145 | 187 |
| to Pivot (H) | | | |
| Tip end to | 74 | 52 | 46 |
| Pivot (T) | | | |
| Ratio H/T | 1.8 | 2.8 | 4.1 |

CHART B
Tip Stiffness

| | | Utility | Side |
|---|---|---|---|
| | Needle | Pliers | Cutting |
| | Nose | 100 | Pliers 200 |
| Tip Length (L) | 50 | 14 | 14 |
| Tip Web (W) | 20 | 18 | 22 |
| Ratio W/L | 0.4 | 1.3 | 1.6 |

Secondly, the small size of tip ends 136 and tip ends 236 allows one to access areas which would not be possible to access with standard utility pliers and or standard linesmen pliers.

Therefore advantages of the present concepts utility pliers 100 and side cutting pliers 200 ore that one can obtain extremely high mechanical advantages at tip ends 136 and 236, as well as high stiffness levels of the needle nose position 109 and 209 thereby allowing one to obtain a very secure grip of an object which would be clamped between tip ends 136 or tip ends 236 between grip surface 150 and or grip surface 250 respectively.

Unfortunately in some instances it is not possible to apply enough pulling force to remove the object that is being gripped between tips 136 or 236. For example, a nail and/or a staple can now be gripped very securely due to the very high mechanical advantage of utility pliers 100 and/or side cutting pliers 200, however it is necessary to apply very strong pulling forces in order to remove a nail, staple and/or other object which may be lodged in wood or another substance. In order to increase the amount of pulling force that the user is able to achieve one can use pry surface 132 to assist in applying additional pulling forces on jaws 102 or jaws 202 by using a pry bar. The tip of the pry bar is placed against pry surface 132 and the pivot of the pry bar is placed against the adjacent surface in which the article to be removed is located. In this manner, very high pulling forces can be accomplished by using pry bars that have very long handles and/or high mechanical advantages thereby creating very high pulling forces on jaws 102 and/or jaws 202. In other words, a pry bar can be used as a secondary lever which is placed between pry bar surface 132 and the surface from which one is trying to extract the unwanted object such as the nail or the staple. In this manner it is easier to extract nails and staples and other objects out of wood or other materials.

Additionally utility pliers 100 can also be used in the traditional manner in which utility pliers are used for gripping articles between serrated surfaces 126 for cutting objects using cutting edge 130 and for gripping articles between broad gripping face 124. Similarly, side cutting pliers 200 can also be used in a traditional sense that linesmen pliers are presently used, namely by using cutting edge 230 for cutting objects and by gripping articles between broad face 224 of jaws 202 in addition to the other features normally found on linesmen pliers which perhaps are not depicted in the drawing. Therefore the present concept utility pliers 100 not only provides for the traditional utility plier functions but in addition provides needle nose functions though with much superior performance have to increased mechanical advantage as well as increased stiffness at the tips. Additionally one is able to more easily apply greater pulling forces for the extraction of nail and staples and other objects in wood or other materials due to the presence of pry surface 132.

Similarly side cutting pliers 200 also can be used in the traditional manner that linesmen pliers are put to however have the additional advantage of the needle nose functions as described above for the utility pliers 100.

I claim:

1. Multifunctional pliers comprising:
a) a right lever and a left lever, with an upper working portion which includes right and left tip ends, at one end respectively, and a handle portion which includes right and left handles, at the other end respectively, the working portion and handle portion connected at the pivot axis, wherein the levers and are of substantially equal length and are pivotally hinged together about the pivot axis which is spaced a preselected distance T from the right and left tip ends, and a preselected distance H from the left and right handle ends, the working portion includes a needle nose portion which extends longitudinally from the tip web W to the right and left tips;
b) the working portion also includes a utility portion extending longitudinally from the pivot axis to the tip web W for rigidly connecting to the needle nose portion;
c) wherein the needle nose portion includes a pry surface which when viewed from the side, extends laterally away from an outer face plane, the pry surface is inclined at an angle theta relative to the lateral direction wherein angle theta is between 2° to 30°.

2. The multifunctional pliers claimed in claim 1 wherein the needle nose portion includes a pry surface extending laterally away from an outer face plane, the pry surface is inclined at an angle theta relative to the lateral direction wherein angle theta is 5°.

3. The multifunctional pliers claimed in claim 2 further include a utility portion extending longitudinally from the pivot axis to the tip web, the utility portion configured for cutting and gripping and includes a cutting portion and gripping portion respectively;

4. The multifunctional pliers claimed in claim 1 wherein the utility portion includes a cutting portion spaced closest longitudinally to the pivot axis, followed by a gripping portion next closest longitudinally to the pivot axis, followed by the needle nose portion spaced furthest longitudinally from the pivot axis.

5. The multifunctional pliers claimed in claim 1 wherein, the needle nose portion when viewed from the side is thickest at the tip web and tapers to the tip ends.

6. The multifunctional pliers claimed in claim 2 wherein, the needle nose portion when viewed from the side is thinner than the overall thickness of the pliers Th at the tip web thereby providing space for the pry surface.

7. The multifunctional pliers claimed in claim 2 wherein, the needle nose portion when viewed from the side is less than 60% of the overall thickness of the pliers Th at the tip web thereby providing space for the pry surface.

8. Multifunctional pliers comprising:
a) a right lever and a left lever, with an upper working portion which includes right and left tip ends at one end respectively, and a handle portion which includes right and left handles, at the other end respectively, the working portion and handle portion connected at the pivot axis, wherein the levers and are of substantially equal length and are pivotally hinged together about the pivot axis which is spaced a preselected distance T from the right and left tip ends, and a preselected distance H from the left and right handle ends;
b) the working portion includes a utility portion extending longitudinally from the pivot axis to a tip web, the utility portion configured for cutting and gripping and includes a cutting portion and gripping portion respectively;
c) the working portion includes a needle nose portion which extends longitudinally from the tip web to the right and left tips.

9. The multifunctional pliers claimed in claim 1 wherein the needle nose portion includes a pry surface which when viewed from the side, extends laterally away from an outer face plane, the pry surface is inclined at an angle theta relative to the lateral direction wherein angle theta is between 2° to 30°.

10. The multifunctional pliers claimed in claim 1 wherein the needle nose portion includes a pry surface extending laterally away from an outer face plane, the pry surface is inclined at an angle theta relative to the lateral direction wherein angle theta is 5°.

11. The multifunctional pliers claimed in claim 1 wherein, the ratio H/T is greater than 2.8 providing a greater mechanical advantage of the needle nose portion than standard needle nose pliers.

12. The multifunctional pliers claimed in claim 1 wherein, wherein the tip length is defined as L and the ratio W/L is greater than 1 3 providing a greater stiffness of the needle nose portion than standard needle nose pliers.
